(19) United States
(12) Patent Application Publication
(10) Pub. No.: US 2007/0097217 A1
(43) Pub. Date: May 3, 2007

(54) IMAGE MANAGEMENT APPARATUS

(75) Inventor: Takashi YAMAMOTO, Kadoma-shi, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 11/539,462

(22) Filed: Oct. 6, 2006

(30) Foreign Application Priority Data
Oct. 11, 2005 (JP) 2005-296275

(51) Int. Cl. H04N 5/225; H04N 9/04

(52) U.S. Cl. 348/207.99

(57) ABSTRACT

The image management apparatus of the present invention is an image management apparatus that can secretly manage an image data, including: an authenticating portion that authenticates an operator; and a controller 15 that has at least a first controlling mode and a second controlling mode, wherein the controlling portion does not perform a control requested by the operator with respect to the image data that is managed secretly, if the authenticating portion does not authenticate the operator as an authorized operator in the first controlling mode, and performs a control requested by the operator with respect to an image data that is to be secretly managed so as to secretly manage the image data, even if the authenticating portion does not authenticate the operator as the authorized operator in the second controlling mode. According to this structure, the image data can be secretly managed, and the operability can be improved.

### BACKGROUND OF THE INVENTION

1. Field of the Invention

The present invention relates to an image management apparatus that can secretly manage an image.

2. Description of Related Art

Recently, there has been an increasing trend to protect private information. Among them, a secret function that also can inhibit a third party to browse an image that is photographed by an photographing apparatus such as a digital still camera is desired. Patent document 1 (JP 2003-134455 A) discloses an example of the secret function of the photographing apparatus.

In the configuration that is disclosed in Patent document 1, a normal recording mode and a secret recording mode can be selected. In the case where the photographing is performed in the secret recording mode, a secret code (a password) is added to a header portion of an image data, and further, the image data is recorded into an information medium.

However, according to the configuration disclosed in Patent document 1, the image that is photographed in the secret recording mode can be protected by a password, but there is a problem in that an image that is photographed at the normal recording mode cannot be converted into a format that can be protected by a password. That is, it is impossible to inhibit a third party to browse the photographed image that is photographed once in the normal recording mode.

### SUMMARY OF THE INVENTION

Therefore, with the foregoing in mind, it is an object of the present invention to provide an image management apparatus that can secretly manage an image data and can improve the operability.

In order to attain the above-mentioned object, a first image management apparatus is an image management apparatus that can secretly manage an image data, including: an authenticating portion that authenticates an operator; and a controlling portion that has at least a first controlling mode and a second controlling mode, wherein the controlling portion does not perform a control requested by the operator with respect to the image data that is managed secretly, if the authenticating portion does not authenticate the operator as an authorized operator in the first controlling mode, and performs a control requested by the operator with respect to an image data that is to be secretly managed so as to secretly manage the image data, even if the authenticating portion does not authenticate the operator as the authorized operator in the second controlling mode.

According to this configuration, in the first controlling mode, authentication of the operator is required, and thus, an image data can be secretly managed. Moreover, in the second controlling mode, since an image data can be secretly managed without the authentication of the operator, any complicated operation is not required, and the operability can be improved.

Moreover, a second image management apparatus is an image management apparatus including: an authenticating portion that authenticates an operator; an image pickup portion that generates an image data; an image processing portion that performs a predetermined process with respect to the image data; a recording portion that records the image data that is processed by the image processing portion into an information medium that can be attached/deteched to or provided in the image management apparatus; a reproducing portion that reproduces the image data that is recorded in the information medium; and a controlling portion that has at least a first controlling mode and a second controlling mode, wherein the controlling portion controls the reproducing portion so as not to reproduce the image data that is recorded in the information medium as an image data to be secretly managed, if the authenticating portion does not authenticate the operator as an authorized operator in the first controlling mode, and controls the recording portion to record the image data that is processed by the image processing portion into the information medium so as to secretly manage the image data, even if the authenticating portion does not authenticate the operator as the authorized operator in the second controlling mode.

According to this configuration, in the case of reproducing an image data, the authentication of the operator is required, and thus the image data can be secretly managed. Furthermore, in the case of recording an image data into an information medium, the authentication of the operator is not required, and thus it is possible to record the image data without any complicated operation, thereby improving the operability.

Therefore, the present invention makes possible to secretly manage an image data, and can improve the operability.

These and other advantages of the present invention will become apparent to those skilled in the art upon reading and understanding the following detailed description with reference to the accompanying figures.

### BRIEF DESCRIPTION OF THE DRAWINGS

FIG. 1 is a plan view showing an external appearance of a photographing apparatus that is provided with an image management apparatus according to Embodiment 1.

FIG. 2 is a block diagram showing a system structure of the photographing apparatus that is provided with the image management apparatus according to Embodiment 1.

FIG. 3 is a schematic view showing a directory construction according to Embodiment 1.

FIG. 4 is a flow chart showing a flow of an initial setting according to Embodiment 1.

FIG. 5 is a schematic view showing displayed contents of a password inputting image according to Embodiment 1.

FIG. 6 is a schematic view showing displayed contents of a dummy image selecting image according to Embodiment 1.

FIG. 7 is a flow chart showing a flow of a shift into a secret mode according to Embodiment 1.

FIG. 8 is a schematic view showing displayed contents of various mode selecting images in the secret mode according to Embodiment 1.

FIG. 9 is a flow chart showing a flow of a secret photographing mode according to Embodiment 1.

FIG. 10 is a schematic view showing a correspondence table according to Embodiment 1.

FIG. 11 is a flow chart showing a flow of a secret reproducing mode according to Embodiment 1.

FIG. 12 is a schematic view showing the displayed contents of the password inputting image according to Embodiment 1.

FIG. 13 is a schematic view showing displayed contents of a secret image according to Embodiment 1.

FIG. 14 is a schematic view showing displayed contents of a dummy image according to Embodiment 1.

FIG. 15 is a schematic view showing displayed contents of a caution message according to Embodiment 1.

FIG. 16 is a flow chart showing a flow of a secret release mode according to Embodiment 1.

FIG. 17 is a flow chart showing a flow of a secret setting mode according to Embodiment 1.

FIG. 18 is a flow chart showing a flow of a reproducing mode according to Embodiment 2.

FIG. 19 is a schematic view showing a directory construction according to Embodiment 3.

### DETAILED DESCRIPTION OF THE INVENTION

### Embodiment 1

(1-1. Entire Configuration of Apparatus)

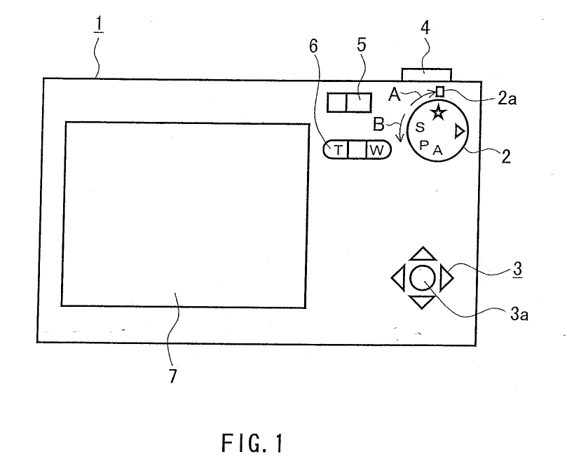

FIG. 1 is a view showing an external appearance of a photographing apparatus that is provided with an image management apparatus according to Embodiment 1. The photographing apparatus shown in FIG. 1 is a digital still camera that can photograph at least a still image.

A photographing apparatus 1 is provided with a mode dial 2, a cursor key 3, a menu button 3a, a release button 4, a power switch 5, a zoom button 6 and a display 7 on a back face (a face on a photographer side) of the photographing apparatus 1. Moreover, an objective lens and a strobe emitting portion (not illustrated) and the like are provided on a front face (a face on a subject side), which is a rear face of the back face of the photographing apparatus 1.

The mode dial 2 has a substantially cylindrical shape, and is provided so as to be able to rotate freely in a direction shown by an arrow A or an arrow B. A mode mark showing each mode is printed on a surface of the mode dial 2, and enables to shift into a desired mode, by matching a position of the mode mark with a position of a mark 2a that is printed on a cabinet of the photographing apparatus 1. The modes that can be selected in the present embodiment include: a shutter speed priority photographing mode (a “S”mark in the figure); a program photographing mode (a “P” mark in the figure); a diaphragm priority photographing mode (an “A” mark in the figure); a reproducing mode (a triangle mark in the figure); and a secret mode (a star mark in the figure). Herein, the shutter speed priority photographing mode, the program photographing mode and the diaphragm priority photographing mode are called “photographing modes”. In the photographing mode, by operating the release button 4, an optical image that is formed in an image pickup device can be captured and converted into a digital image signal, and further can be recorded into a memory card 20 (described below). In the reproducing mode, the image data that is recorded in the memory card 20 can be read out, and can be displayed on the display 7. In the secret mode, the image data can be set so as not to be browsed by a third party. Herein, the modes that can be set by the mode dial 2 are not limited to the above-described modes, and may be other mode, such as a moving image photographing mode in which a moving image can be photographed or reproduced, an apparatus connecting mode in which communication can be performed with other apparatus such as a personal computer, and the like.

The cursor key 3 is composed of: a first cursor button for enabling the operation in an upward direction; a second cursor button for enabling the operation in a downward direction; a third cursor button for enabling the operation in a left direction; and a fourth cursor button for enabling the operation in a right direction. Moreover, at a center of the cursor key 3, a menu button 3a is disposed. For example, when a menu image is displayed on the display 7 by operating the menu button 3a, the cursor key 3 can move a cursor in the menu image and can switch emission of flash to be on or off in the photographing mode.

The release button 4 is disposed on a top face of the photographing apparatus 1. A user can photograph a still image by operating the release button 4.

The user can switch the power of the photographing apparatus 1 to be on or off, by operating the power switch 5.

The user can perform an optical zoom and/or an electronic zoom by operating the zoom button 6. The optical zoom is a zoom method by which a zoom lens that is disposed in the photographing apparatus 1 is moved in an optical axis direction so as to zoom in or out the optical image that is formed in the image pickup device. Moreover, the electronic zoom is a zoom method by which a size of a trimming area in the image pickup device is changed and image processing (scale-up or scale-down processing with respect to a video) is performed, in accordance with the operation of the zoom button 6.

The display 7 can display an image (called a through image) that is picked up by the image pickup device, an image that is read out from the memory card and various menu images. In the present embodiment, the display 7 is composed of a LCD (liquid crystal display).

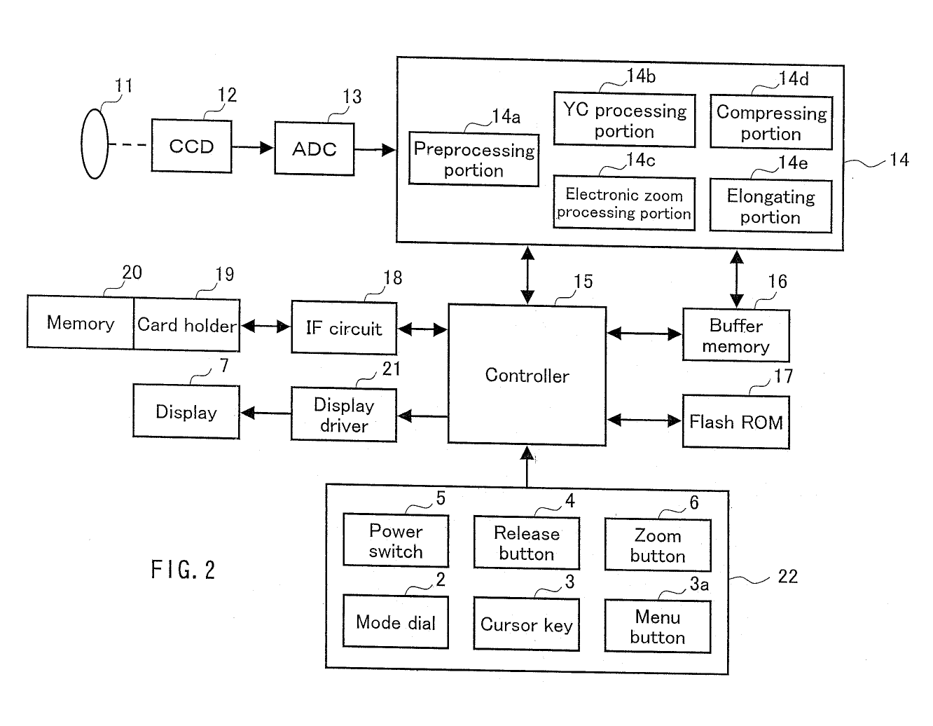

FIG. 2 is a block diagram showing a system structure of the photographing apparatus that is provided with the image management apparatus according to Embodiment 1. In FIG. 2, the same elements as those of FIG. 1 are denoted by the same reference numerals instead of describing them specifically.

As shown in FIG. 2, the photographing apparatus 1 is provided with: a lens 11; an image pickup device (hereinafter, called a CCD) 12; an analog-digital converter (hereinafter, called an ADC) 13; an image processing portion 14; a controller 15; a buffer memory 16; a flash ROM 17; an interface circuit (hereinafter, called an IF circuit) 18; a card holder 19; a memory card 20; a display driver 21; and an operating portion 22.

The lens 11 includes an objective lens, a zoom lens, a focus lens and the like. Moreover, the photographing apparatus 1 is provided with a driving mechanism for driving the zoom lens and the focus lens in the optical direction. Herein, the zoom lens and the focus lens are not necessarily provided.

The CCD 12 is composed of a CCD image sensor that forms the optical image that is incident via the lens 11, and converts it into an electric signal (an analog signal) so as to output it.

The ADC 13 converts the electric signal (the analog signal) that is output from the CCD 12 into a digital signal.

The image processing portion 14 generates an image data from the digital signal that is output from the ADC 13, and performs various kinds of image processing. The image processing portion 14 is provided with: a preprocessing portion 14a; a YC processing portion 14b; an electronic zoom processing portion 14c; a compressing portion 14d; and an elongating portion 14e, for example.

The preprocessing portion 14a can perform a process for adjusting a white balance of the image and a process for performing a gamma correction with respect to the image. The white balance adjustment is a process for adjusting a color of the image so as to be close to a color of an actual object and adjusting the color of the image to be appropriate for a light source (a fluorescent lamp, sunlight and the like). Moreover, the gamma correction process is a process for adjusting a contrast of the image. Herein, the processes that can be performed by the preprocessing portion 14a may include image processing other than the white balance process and the gamma correction process.

The YC processing portion 14b separates the image based on the input image data into: a brightness information “Y”; color difference information “Cb” between a brightness signal and blue; and color difference information “Cr” between the brightness signal and red.

The electronic zoom processing portion 14c is a process for trimming a part (for example, a center) of the image so as to have a predetermined area, and enlarging the trimmed image so as to have a size of the original image by the signal processing. In the process, for example, from a photographed image with 1600×1200 dots, a center part of the image with 1024×768 dots is cut out, and is enlarged into a size of 1600×1200 dots while being subjected to data interpolation. Herein, the electronic zoom processing portion 14c is not necessarily provided.

The compressing portion 14d compresses the image data by a compression method such as JPEG (Joint Photographic Expert Group). Moreover, the elongating portion 14e elongates the compressed image data. For example, in the case of the JPEG format, firstly, a discrete cosine transforming process (a DCT process), in which a ratio between a high frequency component and a low frequency component of the image data is converted into a numerical form, is performed. Next, a quantizing process for expressing grades of a tone and a gradation of the image in a numerical form (the number of quantization bits) is performed. Finally, a data capacity of the image data is compressed by a Huffman coding process. More specifically, in this process, a signal character string of the image data is demitted per certain bits, and a shorter code is provided to a signal character string with a higher frequency of appearance. Herein, the compressing portion 14d and the elongating portion 14e are not necessarily provided, and can be omitted in the case of a method for recording the image without performing the compression process. Moreover, the compression method is not limited to the JPEG format, and may be a GIF (Graphical Interchange Format) format or the like, by which a similar process can be performed.

The controller 15 is connected to: the image processing portion 14, the buffer memory 16; the flash ROM 17; the IF circuit 18; the display driver 21; and the operating portion 22. Moreover, the controller 15 is provided with: a controlling portion that outputs a controlling signal for controlling operations of respective parts, when a controlling signal that is output from the operating portion 22 is input; and an authenticating portion that authenticates the user. The controlling portion includes a first controlling mode and a second controlling mode. The first controlling mode is a mode for controlling the image data that is secretly managed so as not to perform the control that is requested by the user, if an authorized operator is not authenticated by the authenticating portion. Moreover, the second controlling mode is a mode for controlling to secretly manage the image data by performing the control that is requested by the user with respect to the image data to be secretly managed, even if the authorized operator is authenticated by the authenticating portion. Thus, the first controlling mode corresponds to a secret reproducing mode and a secret release mode in the present embodiment. The second controlling mode corresponds to a secret photographing mode and a secret setting mode in the present embodiment. The respective modes will be described below in detail.

In the buffer memory 16, the image data is stored temporarily, when the image processing is performed by the image processing portion 14.

In the flash ROM 17, various kinds of setting information of the photographing apparatus 1 are stored.

The IF circuit 18 converts the image data that is output from the controller 15 into a data format that can be recorded into the memory card 20. Moreover, the IF circuit 18 converts the data that is read out from the memory card 20 into a data format that can be processed by the controller 15.

The memory card 20 as an information medium is attachable/detachable with respect to the card holder 19, and the card holder 19 is provided with an electric contact that enables data communication with the memory card 20, for example. Herein, the card holder 19 is not limited to the above-described configuration, and may have a form depending on a kind of the information medium to be attached.

The memory card 20 is attachable/detachable with respect to the card holder 19, and can store the image data that is photographed by the photographing apparatus. The memory card 20 is provided with a semiconductor memory device such as a flash memory therein.

The display driver 21 converts the image data that is output from the controller 15 into a signal that can be displayed on the display 7. More specifically, the display driver 21 performs a process to convert the digital image data that is output from the controller 15 into an analog image signal, and then performs a process to convert an image size thereof into a size that is suitable for a size of a displayable area of the display 7.

The controlling portion 22 can perform various operations of the photographing apparatus 1. The operating portion 22 is provided with: the mode dial 2; the cursor key 3; the menu button 3a; the release button 4; the power switch 5; and the zoom button 6. Herein, the operating portion 22 includes an operating button and the like that are not illustrated in the figure, but the description thereof will be omitted in the present embodiment.

Next, a photographing operation will be described.

In FIGS. 1 and 2, firstly, the power button 5 is operated so as to switch the power of the photographing apparatus 1 to be on. Then, the electric power is supplied to each of the circuits from a battery (not illustrated) that is provided in the photographing apparatus 1, and a start-up process (operation controlling for opening a lens barrier, resetting process of a microcomputer, or the like) is performed by the photographing apparatus 1. Next, the mode dial 2 is rotated in the direction shown by the arrow A or the arrow B so as to match a position of a mark representing the photographing mode with the position of the mark 2a.

When the photographing apparatus 1 is shifted into the photographing mode, the optical image is incident into the photographing apparatus 1 through the lens 11, and the image is formed in the CCD 12. The CCD 12 converts the incident optical image into an electric signal, and outputs it to the ADC 13. The ADC 13 converts the input electric signal (the analog signal) into a digital signal. The digital signal that is output from the ADC 13 is input into the image processing portion 14.

The preprocessing portion 14a in the image processing portion 14 generates an image data based on the input digital signal, and the white balance process, the gamma correction process and the like are performed. Next, the image data is separated into the brightness signal Y and the color difference signals Cr and Cb by the YC processing portion 14b, where a process for decreasing information amounts of the color difference signals Cr and Cb is performed. Examples of the process for decreasing the information amounts of the color difference signals Cr and Cb include a “4:2:2 down-sampling process” for decreasing the color information of the image in its main scanning direction, a “4:1:1 down-sampling process” for decreasing the color information of the image in its longitudinal and transverse directions and the like. Herein, when the image processing is performed by the preprocessing portion 14a and the YC processing portion 14b, the image data is stored in the buffer memory 16 temporarily, and the image data that is stored in the buffer memory 16 is read out at any time. The image data (uncompressed) that is output from the image processing portion 14 is input into the controller 15.

The controller 15 outputs the image data that is output from the image processing portion 14 to the display driver 21. The display driver 21 converts the input image data (the digital signal) into an analog image signal. Next, the display driver 21 adjusts a size of the image based on the analog image signal into a size that can be displayed by the display 7. Subsequently, the display driver 21 performs control so as to allow the display 7 to display the image. At this time, the image that is displayed on the display 7 is an image (a through image) that is generated by the continuous signal processing by the CCD 12, the ADC 13 and the image processing portion 14.

When the user operates the release button 4 at a desired timing in a state where the through image is displayed on the display 7, the controller 15 outputs a controlling signal to the image processing portion 14. When the controlling signal is input into the image processing portion 14, the compressing portion 14d allows the buffer memory 16 to store the image data that is subjected to the image processing by the preprocessing portion 14a and the YC processing portion 14b, and performs the compression process. More specifically, a discrete cosine transforming process (a DCT process), in which a ratio between a high frequency component and a low frequency component of the image data is converted into a numerical form, and a quantizing process for expressing grades of a tone and a gradation of the image in number of quantization bits, a Huffman coding process for demitting a signal character string of the image data per certain bits and providing a shorter code to the signal character string with a higher frequency of appearance, and the like are performed.

The compressed image data is displayed on the display 7, via the controller 15 and the display driver 21. Moreover, the compressed image data is recorded into the memory card 20 via the card holder 19.

Moreover, by operating the zoom button 6 before operating the release button 4, the optical zoom process and the electronic zoom process are achieved, whereby the size of the image can be increased or decreased. Next, by operating the release button 4, the image data of the image that is scaled up or down may be recorded into the memory card 20.

Next, operations during the reproduction will be described.

Firstly, the mode dial 2 is rotated in the direction shown by the arrow A or the arrow B so as to match a position of a mark that represents the reproducing mode with the position of the mark 2a. Thereby, the photographing apparatus 1 is shifted into the reproducing mode. Next, the controller 15 reads out the information recorded in the memory card 20 that is attached to the card holder 19, via the IF circuit 18. More specifically, the setting information and the image data that are recorded in the memory card 20 are read out. The setting information includes the number of sheets of the images recorded in the memory card 20 that is currently attached, a capacity of the recorded data and the like. Moreover, the image data that is read out is, for example, an image data of one sheet of an image, or a thumbnail data. Herein, the image data that is read out from the memory card 20 is compressed by a predetermined compression method.

The image data that is read out from the memory card 20 is input into the display driver 21 via the IF circuit 18 and the controller 15. The display driver 21 allows the display 7 to display the input image data.

Next, a directory construction of the data that is recorded in the memory card 20 will be described.

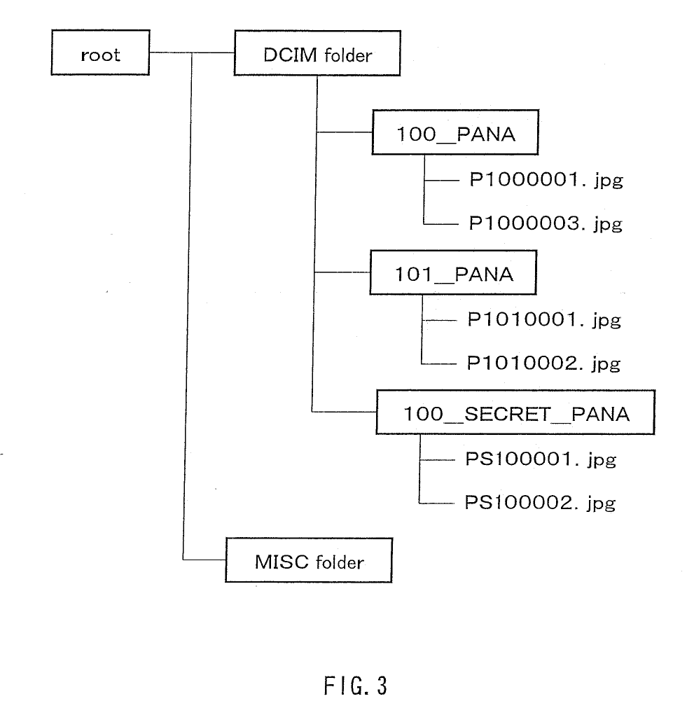

FIG. 3 shows a directory construction of the memory card 20. As shown in FIG. 3, a root directory (a top-end of the directory hierarchy) includes a DCIM folder and a MISC folder. In the DCIM folder, a sub-folder to which a predetermined name is provided is present. In the configuration shown in FIG. 3, the DCIM folder includes sub-folders to which folder names such as “100_PANA”, “101_PANA” etc. are provided, and a sub-holder (hereinafter, called a secret folder) to which a folder name of “100_SECRET_PANA” is provided. In the sub-folders of “100_PANA”, “101_PANA”, etc., files of the image data that is photographed while the photographing apparatus 1 is in the photographing mode are stored. In the secret folder of “100_SECRET_PANA”, a file of the image data that is photographed while the photographing apparatus 1 is in the secret mode is stored.

The file names of the files stored in the respective sub-folders are provided with ordinality, based on a file managing table. According to the configuration shown in FIG. 3, a top first digit of the file name is an alphabet representing the manufacturer of the photographing apparatus 1, top second to fourth digits of the file name are numerals that are top three digits of the sub-folder, and top fifth to eighth digits of the file name are numerals that are provided continuously in each sub-folder. Bottom three digits of the file name denote an extension that represents an attribute of the file. For example, the file names of the file that are stored in the sub-folder of “100_PANA” are “P1000001.jpg”, “P1000002.jpg”, etc. Moreover, the file stored in the secret folder of “100_SECRET_PANA” is provided with a file name representing that the file is subjected to the secret setting. More specifically, the top first digit of the file name is an alphabet representing the manufacturer of the photographing apparatus 1, the top second digit is an alphabet “S” representing a secret image, the top third to fifth digits are characters of the top three digits of the folder name, and the top sixth to eighth digits are numerals that are provided continuously (for example, “PS1000001.jpg). Moreover, the MISC folder stores a file including the various kinds of setting information.

(1-2. Description of Secret Function)

The secret function is a function that can inhibit a third party to browse the image stored in the memory card 20. More specifically, the secret function can set the images in each image file or each secret folder to be inhibited to be browsed by the third party or not. In the below description, a state where the image file is secretly managed, that is, a state where the image file is stored in the secret folder is called a “secret-on”. On the other hand, a state where the image file is not secretly managed, that is, a state where the image file is stored in the sub-folder (for example, the sub-folder of “100_PANA”) except the secret folder is called a “secret-off”. Moreover, an image based on the image file that is set to be secret-on, that is, an image based on the image file that is stored in the secret folder is called a “secret image”. Moreover, an image based on the image file that is set to be secret-off, that is, an image based on the image file that is stored in the sub-folder (for example, the folder of “100_PANA” or the like in FIG. 3) except the secret folder is called an “ordinary image”.

At the time of shifting from the photographing mode or the reproducing mode into the secret mode, the mode dial 2 shown in FIG. 1 is rotated so as to match a position of a star mark printed on the mode dial 2 with the position of the mark 2a. Thereby, the controller 15 shown in FIG. 2 controls the respective portions, whereby the photographing apparatus 1 can be shifted into the secret mode.

(1-2-1. Initial Setting)

A common digital still camera automatically is shifted into a mode for initial setting such as setting of an internal clock, when it is initially powered on by the user after the shipping from the factory. The photographing apparatus 1 of the present embodiment automatically is shifted into a mode for initial setting of the secret mode, in addition to the initial setting described above.

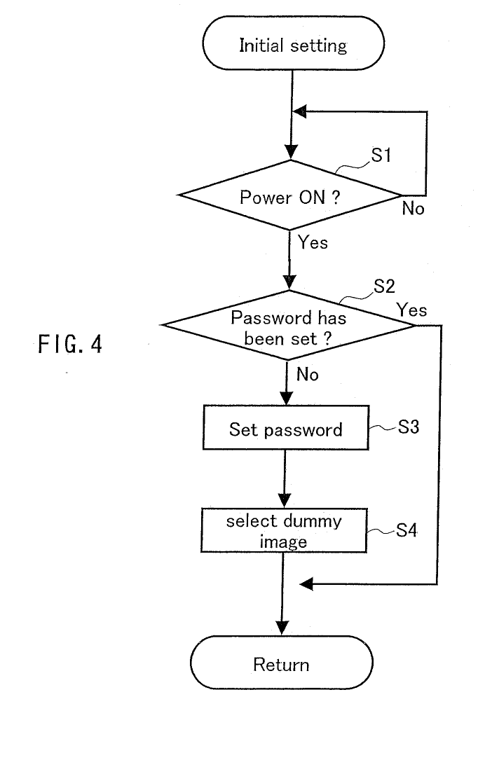

FIG. 4 is a flow chart showing a flow of the initial setting of the secret mode. In FIG. 4, firstly, when the photographing apparatus 1 is powered on (Step S1), the controller 15 shown in FIG. 2 checks the flash ROM 17 whether a password has been already set or not (Step S2). In the case where the password in accordance with the secret function has been set by the user, the password is written in the flash ROM 17, and thus it can be judged whether the password has been set or not, by checking whether the password in the flash ROM 17 has been stored or not. In FIG. 4, in the case where the password is already stored in the flash ROM 17, the process is completed. In the case where the password is not stored in the flash ROM 17, it is shifted into the password setting mode (Step S3).

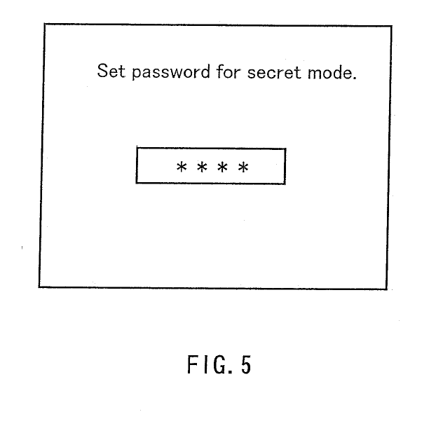

When the photographing apparatus 1 is shifted into the password setting mode, the controller 15 controls the display driver 21 so as to allow the display 7 to display the password inputting image. FIG. 5 shows an example of the password inputting image. As shown in FIG. 5, the password inputting image includes a message for letting the user set the password and an area in which the password is input.

The password can be input by using the cursor key 3 and the menu button 3a shown in FIG. 2. More specifically, in the password inputting image shown in FIG. 5, a list including numerals of “0” to “9” and alphabets of “A” to “Z” is displayed, and a cursor that can be moved by the cursor key 3 is displayed in the list. The user operates the cursor key 3 in upward, downward, left and right directions, and moves the cursor toward a position of a desired letter, thereby operating the menu button 3a. Thereby, the letter that is pointed by the cursor is input as a first digit of the password into the password inputting area. At this time, in the password inputting area, not an alphabet or a numeral is displayed, but an asterisk is displayed. After the input of the first digit is completed, a second digit can be input. A method for the input is the same as the method described above. After all of the digits (four digits in the present embodiment) of the password are completed, the input password is written into the flash ROM 17.

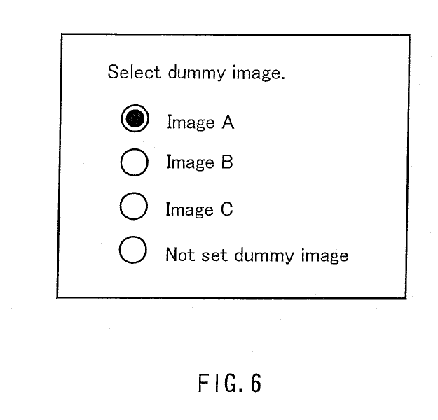

Next, the photographing apparatus 1 is shifted into a mode to select a dummy image (Step S4). The dummy image is an image that is displayed instead of the secret image when the operation for displaying the secret image on the display 7 is performed in the secret mode. When it is shifted into the dummy image selecting mode, the controller 15 controls the display driver 21 so as to allow the display 7 to display the menu image. FIG. 6 is a menu image that enables to select the dummy image. As shown in FIG. 6, in the menu image, a message for letting the user select the dummy image and selection items are displayed. From the selection items, any one of three dummy images (images A to C in FIG. 6) that are written in the flash ROM 17 in advance can be selected. Moreover, it also is possible not to set the dummy images. The user can operate the upward direction button or the downward direction button of the cursor key 3 so as to move a selecting mark (a black point in FIG. 6) in the upward direction or the downward direction, and can select any of the dummy images, in the state where the menu image is displayed as shown in FIG. 6. The user operates the menu button 3a, after selecting the desired dummy image. Thereby, the dummy image can be constituted.

Herein, as the dummy image, the image that is stored in the flash ROM 17 in advance is used, but the image that is stored in the memory card 20 also can be used. In this case, it may be structured so that, for example, the user forms an original dummy image by using a personal computer and image editing software, allows the memory card 20 to store the thus formed original dummy image, attaches the memory card 20 to the card holder 19, and performs a predetermined operation so as to write the original dummy image stored in the memory card 20 into the flash ROM 17. Moreover, the image that is photographed by the photographing apparatus 1 may be used as the dummy image. Thereby, the favorite image of the user can be set as the dummy image.

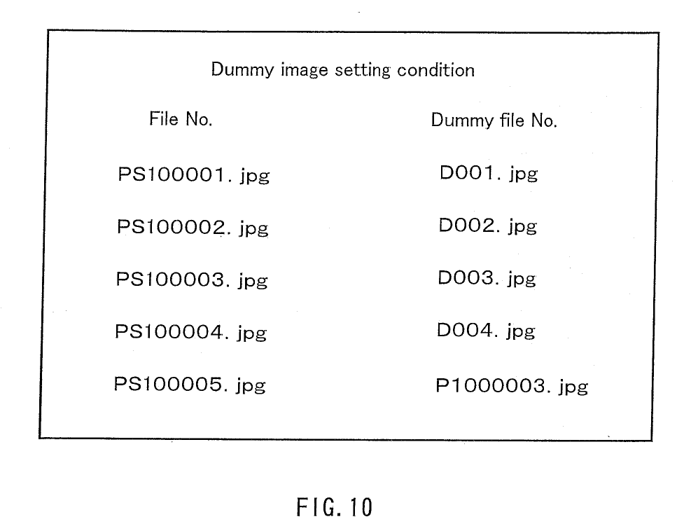

Furthermore, correspondence between the image file and the dummy image is managed in accordance with a correspondence table. FIG. 10 shows an example of the correspondence table. The description of the correspondence table will be provided below.

When the selection of the dummy image is completed, the initial setting is completed.

(1-2-2. Operation to Shift into Secret Mode)

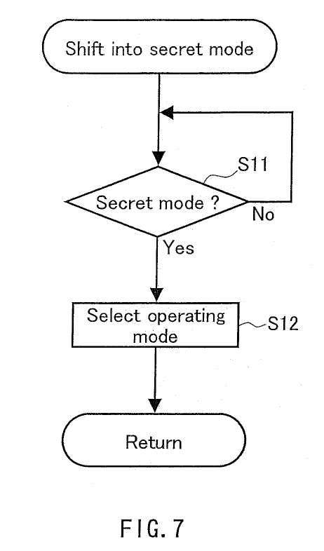

Next, operations when the photographing apparatus 1 is shifted into the secret mode will be described. FIG. 7 is a flow chart showing a flow of the shift into the secret mode.

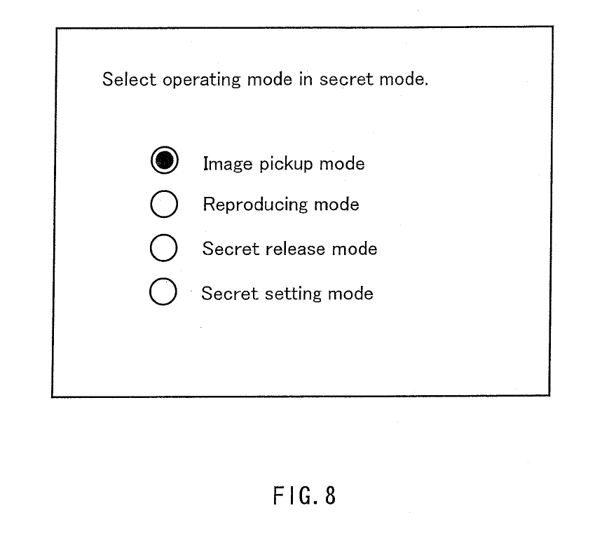

When the mode dial shown in FIG. 1 is rotated so as to shift into the secret mode (Step S11), the controller 15 shown in FIG. 2 reads out the menu image of the secret mode from the flash ROM 17. The controller 15 controls the display driver 21 so as to allow the display 7 to display the menu image. FIG. 8 shows an example of the menu image that is displayed on the display 7 at the time of the shift into the secret mode. As shown in FIG. 8, in the menu image, a message for letting the user select an operating mode and selection items are displayed. The selection items include a photographing mode, a reproducing mode, a secret release mode and a secret setting mode. Herein, the photographing mode in the secret mode is different from the above-described ordinary photographing mode. The reproducing mode in the secret mode is different from the above-described ordinary reproducing mode. Detailed description of the operations thereof will be provided below.

Next, the user selects a desired mode in the menu image that is displayed as shown in FIG. 8 (Step S12). More specifically, the user can operate the upward direction button or the downward direction button of the cursor key 3 so as to move a selecting mark (a black point in FIG. 8) in the upward direction or the downward direction, and can select any of the modes, in the state where the menu image is displayed on the display 7. The user operates the menu button 3a, after selecting the desired mode. Thereby, the various modes in the secret mode can be constituted.

(1-2-3. Operation in Secret Photographing Mode)

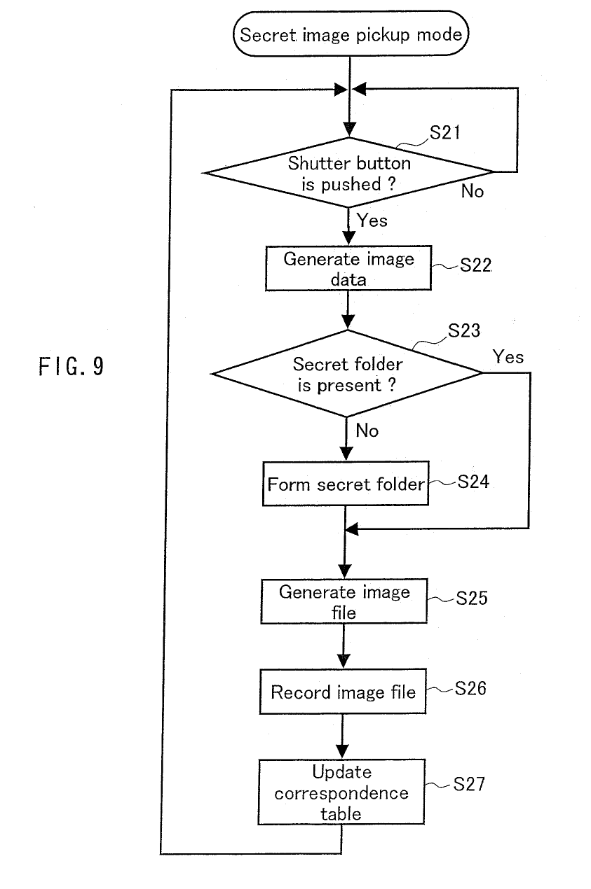

Next, operations when the photographing mode is selected in Step S12 (the menu image shown in FIG. 8) in FIG. 7 will be described. FIG. 9 is a flow chart showing a flow of processes of the photographing mode in the secret mode (hereinafter, called a secret photographing mode).

In FIG. 9, when being shifted into the secret photographing mode, the photographing apparatus 1 becomes in a state where the through image that is picked up by the CCD 12 is displayed on the display 7, similarly to the above-described ordinary photographing mode. In this state, when the release button 4 is operated (Step S21), an image data is generated by the image processing portion 14 as described above (Step S22).

Next, the controller 15 checks whether the secret folder is present in the memory card 20 or not. The presence or absence of the secret folder can be known by referring the directory construction in the memory card 20 (Step S23).

In the case where the secret folder is not present in the memory card 20, the controller 15 forms a secret folder in the memory card 20. At this time, a folder name of the thus formed secret folder is, for example, “100_SECRET_PANA” as shown in FIG. 3. On the other hand, in the case where the secret folder already is present in the memory card 20, the controller 15 does not form secret folder (Step S24).

Next, the controller 15 provides a file name to the generated image data, and generates an image file. At this time, the file name that is provided to the image data is a file name that is peculiar to the secret mode, such as “PS100001.jpg” shown in FIG. 3 (Step S25).

Next, the controller 15 allows the secret folder of the memory card 20 to store the generated image file (Step S26).

Next, the controller 15 updates the correspondence table that is recorded in the flash ROM 17. Herein, the correspondence table is a table for managing the correspondence relationship between the image file of the secret image and the image file of the dummy image (Step S27).

FIG. 10 shows an example of the correspondence table. In the correspondence table shown in FIG. 10, in a row of the file No., file names of the image files of the secret images are listed. Moreover, in a row of the dummy file No. in the correspondence table, file names of the dummy images that correspond to the image files of the respective secret images are listed. For example, as shown in FIG. 10, a file name of a dummy image A (see FIG. 6) is “D001.jpg”. Moreover, a file name of a dummy image B is “D002.jpg”. A file name of a dummy image C, which is not illustrated, is “D003.jpg”. Furthermore, the image file that is recorded in the memory card 20 also can be used as the dummy image. For example, the dummy image that corresponds to the image file “PS100005.jpg” in FIG. 10 is set as the image of “P1000003.jpg” that is recorded in the memory card 20.

In Step S27 in FIG. 9, when an image file is recorded into the secret folder, information of a new image file is added into the correspondence table shown in FIG. 10. At this time, the dummy image that is selected in the above-described initial setting is related to the added image file.

After the update of the correspondence table is completed, the process is returned to Step 21, and it waits until the release button 4 is operated again. That is, all of the images that are photographed in the secret photographing mode are stored into the secret folder.

(1-2-4. Operation of Secret Reproducing Mode)

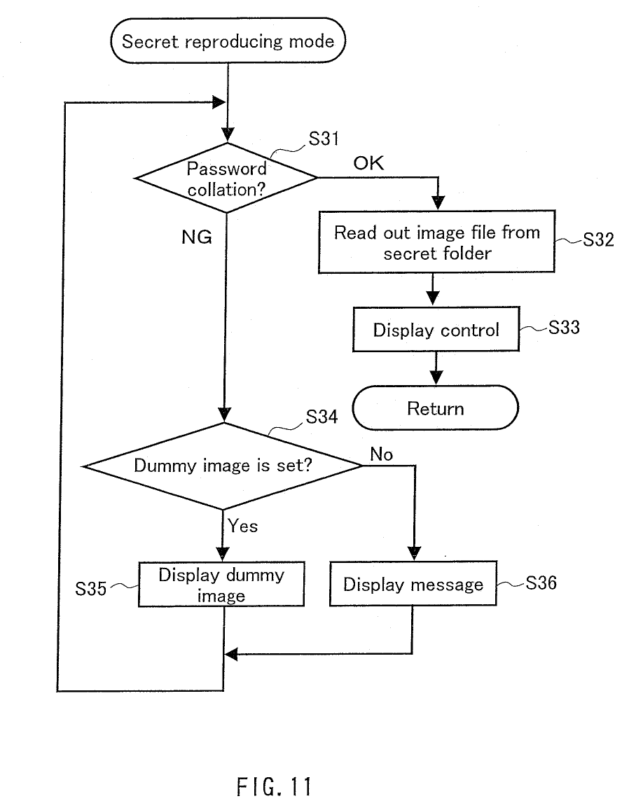

Next, operations in the case where the reproducing mode is selected in Step S12 (the menu image shown in FIG. 8) in FIG. 7 will be described. FIG. 11 is a flow chart showing a flow of processes in the reproducing mode in the secret mode (hereinafter, called a secret reproducing mode).

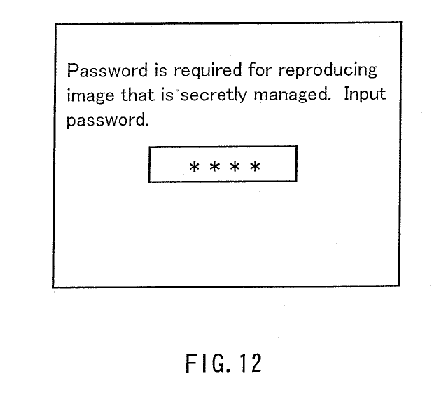

In FIG. 11, when being shifted into the secret reproducing mode, a collating process of the password is performed firstly (Step S31). More specifically, the controller 15 allows the display 7 to display the password inputting image (see FIG. 12) that is recorded in the flash ROM 17. FIG. 12 shows an example of the password inputting image, and this inputting image includes a message for letting the user input the password and an area in which the password is input. The user operates the cursor key 3 and the menu button 3a so as to input the predetermined password into the password inputting area. Herein, the method for inputting the password by using the cursor key 3 has been already described above, and thus the description thereof will be omitted.

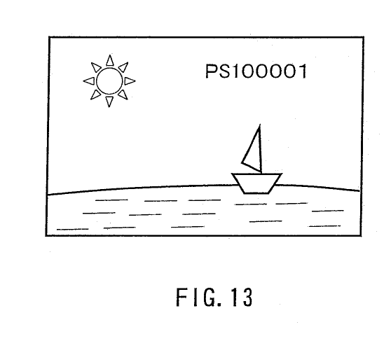

The controller 15 collates the input password with the password that is recorded in the flash ROM 17. In the case where the both passwords are matched with each other, the controller 15 reads out the image file that is recorded in the secret folder (see FIG. 3) of the memory card 20 (Step S32). The controller 15 allows the display 7 to display the secret image based on the image file that is read out (Step S33). FIG. 13 shows an example of the displayed contents of the secret image. As shown in FIG. 13, not only the secret image but also the file name of the image file are displayed. Thereby, the user can browse the secret image.

Whereas, in the password collating process in Step S31, in the case where the password input by the user is not matched with the password that is recorded in the flash ROM 17, the controller 15 refers the setting information (the correspondence table) that is recorded in the flash ROM 17, and checks whether it is set to be displayed the dummy image or not (Step S34).

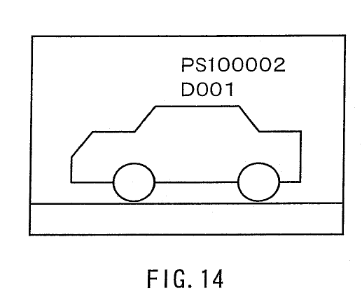

In the case where the dummy image is set to be displayed, the controller 15 reads out the dummy image from the flash ROM 17, and allows the display 7 to display it (Step S35). FIG. 14 shows an example of the displayed contents of the dummy image. As shown in FIG. 14, not only 5 the dummy image but also the file name of the dummy image and the file name of the secret image are displayed. Herein, the file names are not necessarily displayed together with the dummy image.

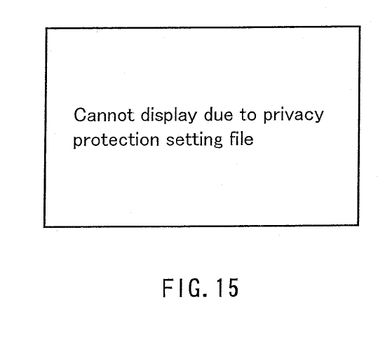

On the other hand, in the case where the dummy image is not set to be displayed, the controller 15 allows the display 7 to display a message (Step S36). FIG. 15 shows an example of the displayed content of the message.

Herein, the dummy image shown in FIG. 14 or the message shown in FIG. 15 may continue to be displayed until the user operates the operating portion 22, or may be switched to the password inputting image shown in FIG. 12 after a certain period of time.

Moreover, after the password is collated in Step S31 of FIG. 11, the result of the collation is valid as long as the secret reproducing mode is continued. That is, if the password is collated once, the images based on the image files that are stored in the secret folder can be browsed freely, as long as the shift from the secret reproducing mode to the other mode does not occur. When, after being shifted from the secret reproducing mode to the other mode, the secret reproducing mode is selected again, the collation of the password is required again.

(1-2-5. Operation in Secret Release Mode)

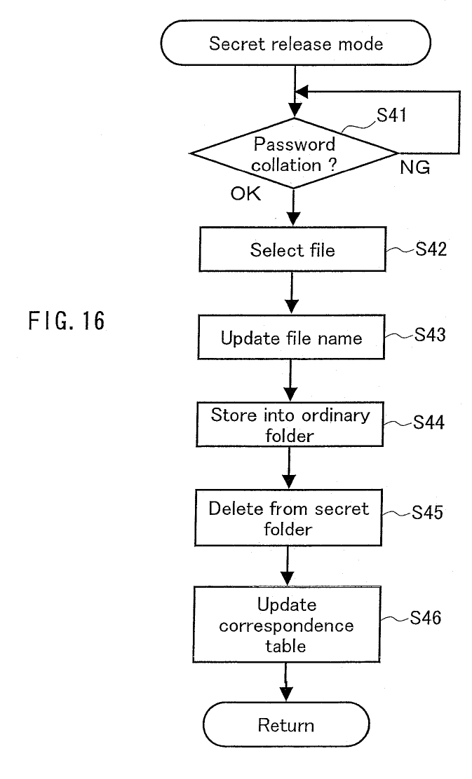

Next, operations in the case where the secret release mode is selected in Step S12 (the menu image shown in FIG. 8) in FIG. 7 will be described. FIG. 16 is a flow chart showing a flow of processes in the secret release mode.

The secret release mode is a mode that can change the state of the secret-on that already is set for each image file or each folder into the state of the secret-off.

In FIG. 16, when the secret release mode is selected, firstly, the collating process of the password is performed. More specifically, firstly, the controller 15 allows the display 7 to display the password inputting image (see FIG. 12) that is recorded in the flash ROM 17. FIG. 12 shows an example of the password inputting image, which includes a message for letting the user input the password and an area in which the password is input. Next, the user operates the cursor key 3 and the menu button 3a so as to input the predetermined password in the password inputting area. Herein, the method for inputting the password by the cursor key 3 has been already described above, and thus the description thereof will be omitted. The controller 15 collates the input passwords with the password that is recorded in the flash ROM 17 (Step S41).

In the case where the both passwords are matched with each other, the controller 15 reads out the image file that is stored in the secret folder (see FIG. 3) in the memory card 20, and allows the display 7 to display the image based on the image file. At this time, in the case where a plurality of the image files are stored in the secret folder, the controller 15 reads out one of the image files, and allows the display 7 to display an image based on the image file. Herein, the number of the image files that are read out from the secret folder is not limited to one, and a plurality of the image files may be read out. Moreover, the number of the images to be displayed on the display 7 is not limited to one, and a plurality of the images may be subjected to thumbnail display.

Next, the user selects the image to be changed into the secret-off, from the images that are displayed on the display 7. More specifically, in the case of changing the one image displayed on the display 7 into the secret-off, the user operates the menu button 3a. Thereby, the image can be selected. Moreover, in the case of changing other image into the secret-off, the user operates the left direction button or the right direction button of the cursor key 3 so as to allow the display 7 to display the image to be changed into the secret-off, and operates the menu button 3a. Furthermore, in the case where thumbnails of a plurality of the images are displayed on the display 7, the user operates the cursor key 3 so as to move the cursor toward the thumbnail image that is to be changed into the secret-off, and operates the menu button 3a. The selected image file is stored into the buffer memory 16 temporarily (Step S42).

Next, the controller 15 performs a control so as to update a file name of the image file that is stored in the buffer memory 16 to be a file name of an ordinary image file. For example, in the case where the image file “PS100001.jpg” is selected, the file name is updated to be “P1010003.jpg”. At this time, the provided file name is the newest file name in the folder that stores the ordinary image files. For example, in the case where the newest file name is “P1010002.jpg” among the image files that are stored in a folder of “101_PANA”, the file name to be provided is “P1010003.jpg” (Step S43).

Next, the controller 15 reads out the image file whose file name is updated from the buffer memory 16, and allows the memory card 20 to store it. At this time, the image file is stored into the ordinary image folder. For example, in the case where the image file to which a file name of “P1010003.jpg” is provided is stored into the memory card 20, it is stored into the folder of “101_PANA” (Step S44).

Next, the controller 15 deletes the original image file of the image file whose file name is updated. More specifically, the image file that its file name is updated and is stored into the ordinary image folder is deleted, among the image files that are stored in the secret folder of the memory card 20 (Step S45).

Next, the controller 15 updates the correspondence table (see FIG. 10) that is stored in the flash ROM 17. More specifically, the information of the image file that is moved from the secret folder to the ordinary image folder is deleted from the correspondence table (Step S46).

As mentioned above, the state of the secret-on of the image file that is stored in the secret folder can be canceled.

Moreover, in Step S42, in the case where the plurality of the image files are selected, the processes of Steps S43 to S46 may be performed with respect to the plurality of the image files at once.

Furthermore, the object of which the state of the secret-on is canceled may be the secret folder. Thereby, the image files that are stored in the secret folder can be shifted from the state of the secret-on into the state of the secret-off at once.

(1-2-6. Operation in Secret Setting Mode)

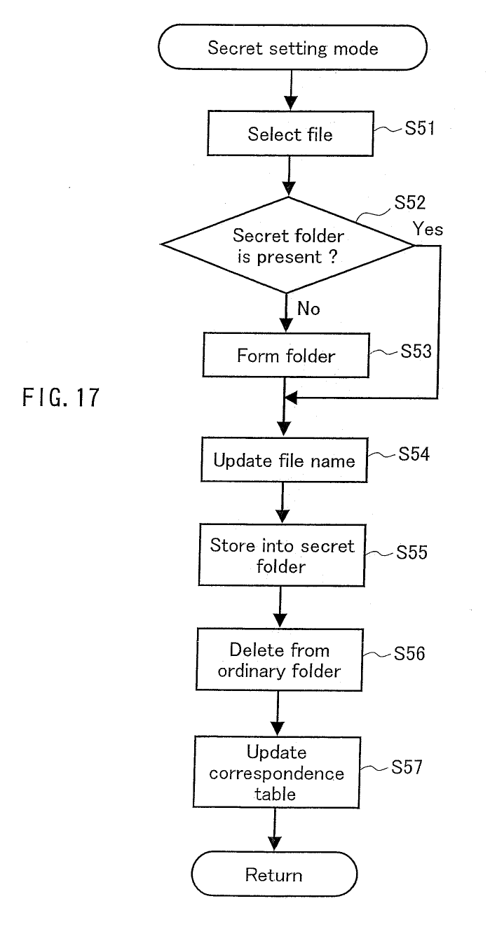

Next, operations in the case where the secret setting mode is selected in Step S12 (the menu image shown in FIG. 8) in FIG. 7 will be described. FIG. 17 is a flow chart showing a flow of processes in the secret setting mode.

The secret setting mode is a mode that can change the image file or the folder in the state of the secret-off into the state of the secret-on. Herein, the input of the password is not required when the photographing apparatus is changed into the secret setting mode.

In FIG. 17, when the secret setting mode is selected, a selecting process of the image file is performed. More specifically, the controller 15 reads out one or a plurality of the image files that are stored in the ordinary image folder of the memory card 20, and allows the display 7 to display the image based on the image file. Next, the user selects the image to be changed into the secret-on from the images that are displayed on the display 7. More specifically, in the state where the images are displayed on the display 7, the menu button 3a is operated. Thereby, the image that is displayed on the display 7 can be selected. Herein, in the case where the other image is changed into the secret-on, the user operates the left direction button or the right direction button of the cursor key 3, allows the display 7 to display the image to be changed into the secret-on, and operates the menu button 3a. Moreover, in the case where thumbnails of a plurality of the images are displayed on the display 7, the user operates the cursor key 3 so as to move the cursor toward the thumbnail image that is to be changed into the secret-on, and operates the menu button 3a. The image file of the selected thumbnail image is stored into the buffer memory 16 temporarily (Step S51).

Next, the controller 15 checks whether the secret folder is present in the memory card 20 or not (Step S52). In the case where the secret folder is not present in the memory card 20, the controller 15 performs a control so as to form a secret folder (Step S53).

Next, the controller 15 performs a control so as to update the file name of the image file that is stored in the buffer memory 16 into a file name of the secret image file. For example, in the case where the image file “P1010001.jpg” is selected, the file name is updated to be “PS100003.jpg”. At this time, the file name to be provided is the newest file name in the secret folder. For example, in the case where the newest file name among the image files that are stored in the secret folder is “PS100002.jpg”, the file name to be provided is “PS100003.jpg” (Step S54).

Next, the controller 15 reads out the image file whose file name is updated from the buffer memory 16, and allows the memory card 20 to store it. At this time, the image file is stored into the secret folder (Step S55).

Next, the controller 15 deletes the original image file of the image file whose file name is updated. More specifically, the image file that its file name is updated and is stored into the secret folder is deleted, among the image files that are stored in the ordinary image folder of the memory card 20. For example, in the present embodiment, since the image file of “P1010001.jpg” is moved into the secret folder, the image file of “P1010001.jpg” that is stored in the folder of “101_PANA” is deleted (Step S56).

Next, the controller 15 updates the correspondence table (see FIG. 10) that is stored in the flash ROM 17. More specifically, the information of the image file that is moved from the ordinary image folder into the secret folder is added into the correspondence table (Step S57).

As described above, the ordinary image file of the memory card 20 can be set in the state of the secret-on.

Herein, in the case where a plurality of the image files are selected in Step S51, the processes of Steps S54 to S57 also may be performed with respect to the plurality of the image files at once.

Furthermore, the object to be set in the state of the secret-on may be the folder that stores the ordinary image files. Thereby, all of the image files that are stored in the folder can be set in the state of the secret-on at once.

Moreover, when setting in the state of the secret-on, a step that can set the dummy image may be added. In this case, for example, in the flow shown in FIG. 17, a message to query the user whether the dummy image to be set or not is displayed, after Step S56. Next, in the case where the user performs an operation for setting the dummy image, when the correspondence table is updated in Step S57, the information of the dummy image in the correspondence table also is updated. On the other hand, in the case where the user performs an operation so as not to set the dummy image, the information of the dummy image in the correspondence table is not updated.

(1-3. Effect of the Present Embodiment and Other)

As described above, the present embodiment is structured so that the secret mode is provided, the image that is photographed in the secret mode is stored not in the image folder that satisfies the standard but in the secret folder that is formed uniquely, whereby the image can be managed secretly.

Moreover, as shown in FIG. 9, in the secret photographing mode, since the input of the password nor the collating process of the password is not required, the swift shift into a photographable state can be performed. Thus, usability thereof while photographing, by which, for example, a shutter chance is not likely to be lost, can be improved.

Furthermore, in the reproducing mode, the secret reproducing mode and the secret release mode, the input of the password nor the collating process of the password is not required, whereby the image can be managed secretly.

Moreover, in the photographing mode, the secret photographing mode and the secret setting mode, the collating process of the password is not necessary, and the user is not required to perform the troublesome input of the password, thereby improving the operability.

Furthermore, since the image file that is recorded in the memory card 20 can be changed into the secret-on or the secret-off, the image or the like that is photographed by other photographing apparatus also can be managed secretly.

### Embodiment 2

(2-1. Outline of Embodiment 2)

An example where an image management apparatus according to Embodiment 2 is provided in a photographing apparatus will be described. A basic structure of the photographing apparatus is as shown in FIGS. 1 and 2. Moreover, a directory construction is structured as shown in FIG. 3. Furthermore, detailed description about FIGS. 1 to 3 will be omitted.

A distinctive point of Embodiment 2 from Embodiment 1 is that, when being shifted into a secret mode by operating the mode dial 2 of FIG. 1, the photographing apparatus 1 is shifted into a secret photographing mode directly. That is, Embodiment 2 does not have the step (Step S12 in FIG. 7) to select the operating mode in the secret mode, unlike Embodiment 1, and it is shifted into the secret photographing mode. Therefore, Embodiment 2 does not have the secret reproducing mode shown in Embodiment 1.

(2-2. Operation in Secret Mode)

Firstly, operations while photographing will be described with reference to FIGS. 1 and 2. In the present embodiment, by shifting the photographing apparatus 1 into the secret mode, it can be shifted into the state where the secret photographing can be performed.

At the time of photographing, the mode dial 2 is rotated into the direction shown by the arrow A or the arrow B so as to match the position of the star mark with the position of the mark 2a. Then, the photographing apparatus 1 becomes in a state where a through image that is picked up by the CCD 12 is displayed on the display 7, similarly to the ordinary photographing mode of Embodiment 1.

While being in this state, when the release button 4 is operated, the image data is generated in the image processing portion 14. The controller provides a file name to the generated image data. At this time, since the mode dial 2 selects the secret mode, the file name that is provided to the image data is a file name for the secret image (for example, “PS100001.jpg”).

Next, the controller 15 allows the secret folder of the memory card 20 to store the generated image file. After that, if the photographing apparatus 1 is in the secret mode, every time when the release button 4 is operated, the image file is stored into the secret folder.

(2-3. Operation in Reproducing Mode)

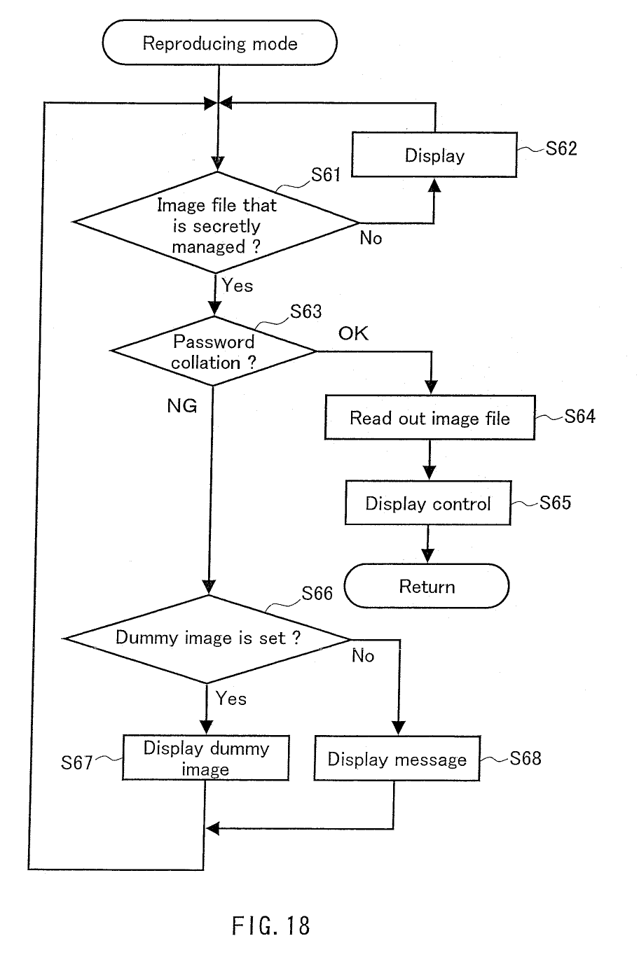

FIG. 18 is a flow chart showing a flow of processes in the reproducing mode in Embodiment 2.

In the present embodiment, when reproducing the image that is based on the image file stored in the memory card 20, the mode dial 2 shown in FIG. 1 is rotated in the direction of the arrow A or the arrow B so as to select the reproducing mode. When the photographing apparatus 1 becomes in the reproducing mode, the controller 15 reads out one of the image files that are recorded in the memory card 20.

Herein, the controller 15 confirms the file name of the image file that is read out, and judges whether it is the image file that is set to be the secret-on (Step S61). In the case where the file name of the image file that is read out from the memory card 20 is a file name of the ordinary image (for example, “P1000001.jpg” shown in FIG. 3), the controller 15 allows the display 7 to display the image based on the image file (Step S62). On the other hand, in the case where the file name of the image file that is read out from the memory card 20 is a file name for the secret image (for example, “PS100001.jpg” shown in FIG. 3), the collating process of the password is performed (Step S63).

More specifically, in the password collating process, the controller 15 allows the display 7 to display a password inputting image (see FIG. 12) that is recorded in the flash ROM 17. The user operates the cursor key 3 and the menu button 3a so as to input the predetermined password in a password inputting area. Herein, the method for inputting the password by the cursor key 3 is already described, and thus will be omitted.

The controller 15 collates the input password with the password that is recorded in the flash ROM 17. When both of the passwords are matched with each other, the controller 15 reads out the image file that is recorded in the secret folder (see FIG. 3) of the memory card 20 (Step S64). The controller 15 allows the display 7 to display the image that is based on the read out image file (Step S65).

Thereby, the user can browse the image that is set to be the secret-on.

On the other hand, in the case where the password that is input by the user is not matched with the password that is recorded in the flash ROM 17 in the password collating process is Step S63, the controller 15 refers the setting information (the correspondence table) that is recorded in the flash ROM 17, and checks whether it is set to display the dummy image or not (Step S66).

In the case where it is set to display the dummy image, the controller 15 reads out the dummy image from the flash ROM 17, and allows the display 7 to display it (Step S67). On the other hand, in the case where it is set not to display the dummy image, the controller 15 allows the display 7 to display a message (see FIG. 16) (Step S67).

Next, in the state where the ordinary image or the dummy image is displayed on the display 7, by operating the left direction button or the right direction button of the cursor key 3, the next image file is read out from the memory card 20. The processes after that are similar to the processes after Step S61 in FIG. 18, and thus description thereof will be omitted.

That is, in the case of reproducing the image by the photographing apparatus of the present embodiment, the reproduction is performed in the ordinary reproducing mode, and only in the case of displaying the secret image, the display 7 displays the dummy image or the message.

Moreover, the dummy image shown in FIG. 14 or the message shown in FIG. 15 may continue to be displayed until the user operates the operating portion 22, or may be switched to the password inputting image shown in FIG. 12 after a certain period of time.

Furthermore, it also may be structured so that, if the password is authenticated once, the control with respect to a plurality of the secret images is allowed until the reproducing mode is over. According to such a structure, in the case where there are a plurality of the secret images, a process to input the password every time when opening one of the secret images can be saved, thereby improving the operability.

(2-4. Operation of Secret Setting and Canceling)

Moreover, in Embodiment 2, the operation to change the image file or the folder that is in the state of the secret-on into the state of the secret-off, or the operation to change the image file or the folder that is in the state of the secret-off into the state of the secret-on can be performed when the photographing apparatus 1 is in the reproducing mode.

More specifically, in the state where the mode dial 2 selects the reproducing mode, and the display 7 displays the image based on the image file that is read out from the memory card 20, when the user performs a predetermined operation (for example, operates the downward direction button of the cursor key 3), the photographing apparatus 1 becomes in a state where the secret setting of the image file that is currently selected can be changed. Operations after that are similar to the above-described flow (the flow in the secret setting mode) shown in FIG. 17, and thus description thereof will be omitted.

Whereas, when the dummy image is displayed on the display 7 (that is, while accessing the image file of which the secret setting is on), the downward direction button of the cursor key 3 is operated, then the photographing apparatus 1 becomes in a state where the secret setting of the image file that is currently selected can be changed. Operations after that are similar to the above-described flow (the flow in the secret release mode) shown in FIG. 16, and thus description thereof will be omitted.

Moreover, while accessing the image file of which the secret setting is on, the message shown in FIG. 15 may be displayed on the display 7. Also in this case, it can be shifted into a state where the secret setting of the image file that is selected at this time can be changed.

(2-5. Effect of Embodiment 2 and Other)

As described above, according to the present embodiment, when performing the secret photographing, the complicated menu operation is not required, and thus the secret photographing can be performed swiftly. Thus, the usability of the photographing apparatus 1 can be improved.

### Embodiment 3

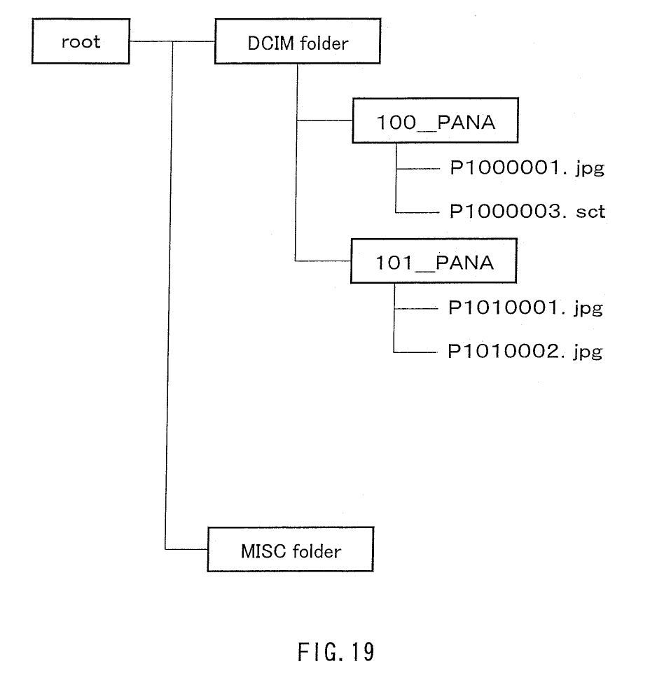

Embodiment 3 has a feature that, when the secret setting of an image file is changed to be set on, an extension of the image file is changed. FIG. 19 is a view showing a directory construction according to Embodiment 3.

Firstly, by operating the mode dial 2 and the cursor key 3 shown in FIGS. 1 and 2, the photographing apparatus 1 is shifted into the secret setting mode. Next, the user operates the cursor key 3 so as to select the image file whose secret setting is to be on (for example, select an image file with a file name of “P1000003.jpg” shown in FIG. 3).

Herein, when the user selects the image file, the controller 15 performs a control so as to change the extension of the file name of the selected image file. More specifically, the extension before the change is “jpg” or the like that satisfies the JPEG standard that is one of the image compressing standards, but is changed into “sct” by the controller 15. Thus, when the secret setting of the image file of “P1000003.jpg” is changed to be on, the file name is changed into “P1000003.sct”.

As shown in FIG. 19, when the memory card 20 including the file with the extension of “sct” is attached to the card holder 19, and the photographing apparatus 1 is shifted into the reproducing mode, the image that is based on the image file with the extension of “jpg” is displayed on the display 7. However, since the file with the extension of “sct” is not acknowledged as an image file by the controller 15, the display 7 does not display any information concerning “P1000003.sct”.

Moreover, in the case where the secret setting is off, by operating the mode dial 2 and the cursor key 3 shown in FIGS. 1 and 2, the photographing apparatus 1 is shifted into the secret release mode. Next, the password collating process is performed, and the image file that is set to be the secret-on (that is, the image corresponding to “P1000003.sct” is displayed on the display 7) is selected. Next, the secret setting of the selected image file is changed to be off. The flow hitherto is similar to the above-described flow of FIG. 16. The controller 15 changes the extension of the image file, whose secret setting is changed to be off, from “sct” to “jpg”. Thereby, the secret setting becomes off.

As mentioned above, according to the present embodiment, the file is not transferred between the folders, which makes the management of the image easy.

Moreover, since the extension of the image file is changed into a signal character string that is not related to a still image format, the image can be secretly managed, also by an apparatus that can access data that is stored in a memory card, such as a personal computer and a television receiving set.

### Embodiment 4

Embodiment 4 includes various examples of the image management apparatus. Each of the examples of Embodiment 4 will be described below.

As the image reproducing apparatus according to Embodiments 1 to 3, the digital still camera was exemplified, but the image reproducing apparatus is not limited to this. For example, the present invention can be achieved also by an image reproducing apparatus that can display at least a digital still image, for example, a digital video camera, a mobile phone or the like that is provided with an image pickup device.

Moreover, the memory card 20 according to Embodiments 1 to 3 is an example of an information medium that can record and reproduce data in the apparatus, and as a replace of the memory card 20, an optical disk, a magnetic disk, a magnetic tape or the like may be used. Furthermore, plural kinds of information media also may be provided. Moreover, the information medium is not limited to be an attachable/detachable type, and may be internally fixed type such as a semiconductor memory.

Furthermore, the display 7 according to Embodiments 1 to 3 is composed of a LCD, but may be provided with other displaying device. Examples of the other displaying device than the LCD include an organic EL display, a CRT (cathode ray tube) display, a plasma display and the like. The organic EL display consumes less power consumption than the LCD, and thus can save power consumption of the image management apparatus. Moreover, the CRT and the plasma display can display images with higher brightness and high reproducibility of colors, and thus can display images with higher quality, compared with the LCD or the organic EL display.

Moreover, the mode dial 2 according to Embodiments 1 to 3 is an example of the mode setting means, and the mode dial 2 is not limited to this, as long as it can at least select the photographing mode. For example, it may have a structure where the display 7 is composed of a touch panel-type LCD, by which the user can perform the mode selection by display touching operation. Furthermore, it also may be structured so that a photographing mode menu displayed on the display 7 can be selected by using, for example, the cursor key. By using them, the members in the operation system can be reduced, which can lead to the enhancement of the degree of freedom for designing, and a reduction of the manufacturing cost due to the decrease of the number of the members.

Moreover, the CCD 12 according to Embodiments 1 to 3 is an example of the image pickup device, and may be a device that can at least convert an incident optical image into an electric signal. For example, the CCD 12 can be composed of a CMOS image sensor instead of the CCD image sensor, thereby reducing the size and the power consumption of the photographing apparatus 1.

Furthermore, Embodiments 1 to 3 have a structure where the input of the password and the setting of the dummy image were performed, by operating the cursor key 3 and the menu button 3a, but the structure is not limited to this, and it also may have a structure where a touch sensor and a touch panel-type LCD are provided so as to be operated. More specifically, the cursor key 3 and the menu button 3a are replaced by a button-type switch device, and is composed of a touch sensor-type switch device. Thereby, there was no projection nor depression in an appearance, thus improving the designability. Moreover, in the case where the display 7 is composed of the touch panel, the display 7 displays a list of characters that can be input (for example, a list of alphabets and numerals) at the time of inputting the password. The user touches the list of the characters displayed on the display 7 by his/her finger so as to input the password. As mentioned above, by using the touch panel as the display 7, the members in the operating system on the cabinet of the image management apparatus can be reduced, which can lead to the reduction of the cost due to the decrease of the number of the members. Furthermore, by the reduction of the members in the operating system, the display 7 in a larger size can be provided, thereby improving the viewability of the image.

Moreover, in Embodiments 1 to 3, the compressing portion 14d and the elongating portion 14e are not necessarily provided. For example, it may be structured so that the image data that is output from the ADC 13 is recorded into the memory card 20 without being compressed. Thereby, the high-quality image data with no loss of data caused by the compression process can be recorded into the memory card 20.

Moreover, the folder name of the secret folder in Embodiments 1 and 2 was just an example. The folder name of the secret folder may be different depending on a manufacturer of the image management apparatus, and may be provided arbitrarily by the user.

Moreover, in Embodiment 1, when selecting the dummy image at the initial setting (see FIG. 6), the display 7 may display the thumbnails of the dummy images. Thereby, the user can select the desired dummy image easily.

Furthermore, Embodiments 1 to 3 have a structure where the password (the authentication password) that is set at the initial setting was stored in the flash ROM 17, but may have a structure where it is stored in the memory card. Moreover, the dummy image, the menu image related to the secret setting and the program for operating the secret function were structured to be stored in the flash ROM 17, but may be structured to be stored in the memory card 20. According to such a structure, the secret function can be operated even when the information medium is attached to other displaying device.

Furthermore, in Embodiment 1, the relationship between the secret image and the dummy image as shown by the correspondence table may be changed by the operation by the user. An example of the method for changing the dummy image includes: firstly performing the password collation; subsequently selecting the secret image of which the dummy image is to be changed; and thereafter allowing the display 7 to display the menu image (for example, see FIG. 6) by which the setting of the dummy image can be changed. The user operates the cursor key 3 while watching the menu image that is displayed on the display 7, and selects the other dummy image or the image that is stored in the memory card 20. Herein, since the relationship between the image file and the dummy image is managed according to the correspondence table shown in FIG. 10, the correspondence table is updated by the change of the dummy image.

Moreover, in Embodiment 1, the setting of the dummy image that is set at the initial setting (see FIG. 6) also may be changed without the password collation. That is, the change of the dummy image does not require the password collation, because the images stored in the memory card 20 are not displayed on the display 7. According to such a structure, the input of the password is not required, thereby improving the usability.

Moreover, in Embodiments 1 to 3, it also may be structured so that the correspondence table (see FIG. 10) between the secret image and the dummy image can be displayed on the display 7. More specifically, in the menu image (not illustrated) that is displayed on the display 7 by operating the menu button 3a, a menu item of “dummy image setting condition” is added. When the menu item is selected, the correspondence table shown in FIG. 10 can be displayed. Moreover, it also may be structured so that, in the thus displayed correspondence table, the relationship between the secret image and the dummy image can be changed.

Furthermore, in Embodiments 1 to 3, as the correspondence table (see FIG. 10) between the secret image and the dummy image, a list of all of the image files stored in the memory card 20 may be displayed. In the case of displaying the list of all of the image files stored in the memory card 20, an item of a “setting condition” is added into the correspondence table, and setting conditions such as an “original data” and “now dummy image setting” may be displayed in each image file.

Moreover, in Embodiment 3, the extension of “sct” is just an example, and the extension is not limited to this, as far as it cannot be acknowledged by at least the apparatus that can display a digital still image. As described above, by changing the extension of the image file into a format that cannot be acknowledged by the photographing apparatus 1, the image file of which the secret setting is on can be inhibited to be displayed by the display 7.

Furthermore, Embodiment 3 also can have a structure where, when reproducing the file with the extension of “sct”, the controller 15 reads out the dummy image from the flash ROM 17 and allows the display 7 to display it. Thereby, the user can acknowledges the presence of the image file whose secret setting is on in the memory card 20.

Moreover, in Embodiments 1 to 3, the user is authenticated by the password collating, but it can be achieved by other collating method. Examples of the collating method include face authentication, fingerprint authentication, voice authentication, authentication by a combination or an order of the operations of the operating portion and the like. For example, in the face authentication, the face of the user (the registerer) is photographed by the apparatus in advance, and the face image is stored into the flash ROM 17. At the time of the collating process, a face of a person who is going to use the apparatus is photographed, which is compared with the face image that is stored in the flash ROM 17. The controller 15 compares the face image of the user with the face image of the registerer that is stored in the flash ROM 17, and checks whether main features of the faces are matched with each other or not. In the case of being matched, the browse of the image is permitted, but in the case of being not matched, the browse of the image is inhibited. Moreover, in the fingerprint authentication, a fingerprint of a hand of the registerer similarly is photographed and registered in advance, and a fingerprint of a hand of the user that is photographed during the collating process is compared with that of the registerer, whereby the browse of the image is permitted or inhibited. Moreover, in the voice authentication, a voice of the registerer is absorbed and recorded by an internal microphone in advance, which is collated with a voice of the user that is absorbed during the collating process, whereby the browse of the image is permitted or inhibited. Furthermore, in the authentication by the operations of the operating portion, only when the respective buttons of the operating portion are operated in the predetermined order, the browse of the image is permitted. For example, only when the menu button 3a, the release button 4, the zoom button 6, the menu button 3a are operated in this order, the browse of the image is permitted, but in the case where a button other than the above-described buttons is operated, or the order is different from the above-described order, the browse of the image is inhibited. Moreover, the authentication by the operations of the operating portion may be performed based on not only the order of the respective buttons of the operating portion but also the combination thereof. For example, only when the menu button 3a and the release button 4 are pushed at the same time, the browse of the image is permitted.

Moreover, in Embodiment 1, when the dummy image is displayed on the display 7 (see FIG. 14), the file name of the dummy image is displayed, but may not necessarily be displayed. By not displaying the file name of the dummy image, it can make difficult for a third party to know that the image is subjected to the secret setting.

Furthermore, Embodiments 1 to 3 have a structure where one user can set one password, but may have a structure where a plurality of passwords can be set. Thereby, when a plurality of users share to use this apparatus, privacies of the respective users can be protected.

Moreover, one image may be related to a plurality of passwords. Thereby, when a plurality of users share to use this apparatus, the plurality of the users can be permitted to browse one image.

Furthermore, the image management apparatus of the present invention can be achieved with structures described below.

A first image management apparatus of the present invention is an image management apparatus that can secretly manage an image data, including: an authenticating portion that authenticates an operator; and a controlling portion that has at least a first controlling mode and a second controlling mode, wherein the controlling portion does not perform a control requested by the operator with respect to the image data that is managed secretly, if the authenticating portion does not authenticate the operator as an authorized operator in the first controlling mode, and performs a control requested by the operator with respect to an image data that is to be secretly managed so as to secretly manage the image data, even if the authenticating portion does not authenticate the operator as the authorized operator in the second controlling mode. The authenticating portion in the above-described configuration corresponds to the controller 15 and the flash ROM 17 according to Embodiments 1 to 3. That is, the controller 15 is structured to collate the password that is written in the flash ROM 17 in advance with the password that is input by the user. Herein, the medium in which the password is written in advance is not limited to the flash ROM 17, but may be the memory card 20 or other information medium. Moreover, the controlling portion in the above-described configuration corresponds to the controller 15 according to Embodiments 1 to 3. Furthermore, the first controlling mode corresponds to the reproducing mode and the secret release mode, and the second controlling mode corresponds to the photographing mode and the secret setting mode.

According to this configuration, the authentication is required in the first controlling mode, and thus the image data can be secretly managed. Moreover, in the second controlling mode, the authentication is not required, and thus the control can be performed with respect to the image data without any complicated operation, thereby improving the operability.

Moreover, a second image management apparatus is an image management apparatus including: an authenticating portion that authenticates an operator; an image pickup portion that generates an image data; an image processing portion that performs a predetermined process with respect to the image data; a recording portion that records the image data that is processed by the image processing portion into an information medium that can be attached/deteched to or provided in the image management apparatus; a reproducing portion that reproduces the image data that is recorded in the information medium; and a controlling portion that has at least a first controlling mode and a second controlling mode, wherein the controlling portion controls the reproducing portion so as not to reproduce the image data that is recorded in the information medium as an image data to be secretly managed, if the authenticating portion does not authenticate the operator as an authorized operator in the first controlling mode, and controls the recording portion to record the image data that is processed by the image processing portion into the information medium so as to secretly manage the image data, even if the authenticating portion does not authenticate the operator as the authorized operator in the second controlling mode. In the case of reproducing the image data with this configuration, the authentication of the operator is required, and thus the image data can be secretly managed. Furthermore, in the case of recording the image data into the information medium, the authentication of the operator is not required, and thus the image data can be recorded without any complicated operation, thereby improving the operability. The authenticating portion in the above-described configuration corresponds to the controller 15 and the flash ROM 17 according to Embodiments 1 to 3. That is, the controller 15 is structured to collate the password that is written in the flash ROM 17 in advance with the password that is input by the user. Herein, the medium in which the password is written in advance is not limited to the flash ROM 17, but may be the memory card 20 or other information medium. Moreover, the photographing portion in the above-described configuration corresponds to the lens 11 and the CCD 12 according to Embodiments 1 to 3. The image processing portion corresponds to the image processing portion 14 according to Embodiments 1 to 3. The contents to be processed by the image processing portion 14 is not limited to those described in Embodiments 1 to 3, and can exclude the electronic zoom processing portion 14c or include other element related to the image processing. The information medium corresponds to the memory card 20 according to Embodiments 1 to 3, but the type of the medium is not limited to the memory card that is provided with the semiconductor memory, and may be composed of a medium of an optical system, a magnetic system or the like. The recording portion or the reproducing portion corresponds to the IF circuit 18 according to Embodiments 1 to 3. IF circuit 18 is not limited to the circuit that can record the image data or the like into the memory card 20 or reproduce the image data or the like from the memory card 20, and may have a form in accordance with the information medium to be used in the apparatus. The controlling portion corresponds to the controller 15 according to Embodiments 1 to 3.

Moreover, a second image management apparatus of the present invention may have a configuration further including a displaying portion that can display an image based on the image data, wherein, when a request to reproduce a first image data that is secretly managed is input in the first controlling mode, the controlling portion performs a control so as to allow the displaying portion to display an image based on a second image data instead of the first image data. According to this configuration, the image based on the first image data that is secretly managed can be inhibited to be displayed, and the browse of the image based on the first image data by a third party can be inhibited. The displaying portion in the above-described configuration corresponds to the display 7 and the display driver 21 according to Embodiments 1 to 3. The displaying portion includes all types that can display at least an image based on image data.

Moreover, it may have a configuration where, when allowing the displaying portion to display the image based on the second image data, the controlling portion allows the displaying portion to display: the image based on the second image data; and information concerning the second image data. According to this configuration, the operator can acknowledge that the image based on the second image data instead of the first image data is displayed.

Furthermore, it may have a configuration where, when recording the image data that is processed by the image processing portion and is to be secretly managed into the information medium, the controlling portion changes an extension of an image file that includes the image data into an extension that cannot be acknowledged by the image management apparatus, and controls the recording portion to record the image data into the information medium. According to this configuration, the image file can be managed easily. Moreover, in an apparatus that can reproduce an image file that satisfies the sill image standard, the image based on the image file that is secretly managed can be inhibited to be displayed.

Moreover, it may have a configuration where the authenticating portion authenticates the operator by collating an authentication password that is set in the image management apparatus in advance with an input password that is input by the operator, a plurality of the authentication passwords can be set, and the controlling portion controls the reproducing portion so that the image data that can be reproduced by each of the authentication password is different. According to this configuration, in the case where a plurality of operators share to use one apparatus, by setting a password for each of the operators, the reproducible image data can be limited for each of the operator.

Furthermore, it may have a configuration where the authenticating portion authenticates the operator by collating an authentication password that is set in the image management apparatus in advance with an input password that is input by the operator, a plurality of the authentication passwords can be set with respect to one image data, and the controlling portion controls the reproducing portion to reproduce the image data that is secretly managed, if the input password is matched with at least one authentication password among the plurality of the authentication passwords. According to this configuration, the browsable operator can be limited for each image data.

The image management apparatus of the present invention is usefully applied to an apparatus that can reproduce at least an image file, such as a photographing apparatus, for example, a digital still camera and the like.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An image management apparatus that can secretly manage an image data, comprising:
an authenticating portion that authenticates an operator; and
a controlling portion that has at least a first controlling mode and a second controlling mode,
wherein the controlling portion
does not perform a control requested by the operator with respect to the image data that is managed secretly, if the authenticating portion does not authenticate the operator as an authorized operator in the first controlling mode, and
performs a control requested by the operator with respect to an image data that is to be secretly managed so as to secretly manage the image data, even if the authenticating portion does not authenticate the operator as the authorized operator in the second controlling mode.

2. An image management apparatus comprising:
an authenticating portion that authenticates an operator;
an image pickup portion that generates an image data;
an image processing portion that performs a predetermined process with respect to the image data;
a recording portion that records the image data that is processed by the image processing portion into an information medium that can be attached/deteched to or provided in the image management apparatus;
a reproducing portion that reproduces the image data that is recorded in the information medium; and
a controlling portion that has at least a first controlling mode and a second controlling mode,
wherein the controlling portion
controls the reproducing portion so as not to reproduce the image data that is recorded in the information medium as an image data to be secretly managed, if the authenticating portion does not authenticate the operator as an authorized operator in the first controlling mode, and
controls the recording portion to record the image data that is processed by the image processing portion into the information medium so as to secretly manage the image data, even if the authenticating portion does not authenticate the operator as the authorized operator in the second controlling mode.

3. The image management apparatus according to claim 2, further comprising a displaying portion that can display an image based on the image data,
wherein, when a request to reproduce a first image data that is secretly managed is input in the first controlling mode, the controlling portion performs a control so as to allow the displaying portion to display an image based on a second image data instead of the first image data.

4. The image management apparatus according to claim 3, wherein, when allowing the displaying portion to display the image based on the second image data, the controlling portion allows the displaying portion to display: the image based on the second image data; and information concerning the second image data.

5. The image management apparatus according to claim 2, wherein, when recording the image data that is processed by the image processing portion and is to be secretly managed into the information medium, the controlling portion changes an extension of an image file that includes the image data into an extension that cannot be acknowledged by the image management apparatus, and controls the recording portion to record the image data into the information medium.

6. The image management apparatus according to claim 2, wherein
the authenticating portion authenticates the operator by collating an authentication password that is set in the image management apparatus in advance with an input password that is input by the operator,
a plurality of the authentication passwords can be set, and
the controlling portion controls the reproducing portion so that the image data that can be reproduced by each of the authentication password is different.

7. The image management apparatus according to claim 2, wherein
the authenticating portion authenticates the operator by collating an authentication password that is set in the image management apparatus in advance with an input password that is input by the operator,
a plurality of the authentication passwords can be set with respect to one image data, and
the controlling portion controls the reproducing portion to reproduce the image data that is secretly managed, if the input password is matched with at least one authentication password among the plurality of the authentication passwords.
